(19) United States
(12) Patent Application Publication
(10) Pub. No.: US 2018/0076702 A1
(43) Pub. Date: Mar. 15, 2018

(54) VIBRATION MOTOR

(71) Applicant: Nidec Seimitsu Corporation, Ueda-shi (JP)

(72) Inventors: Zendi MORI, Ueda-shi (JP); Mitsuru MURATA, Ueda-shi (JP); Yuki TOHATA, Ueda-shi (JP)

(21) Appl. No.: 15/704,133

(22) Filed: Sep. 14, 2017

Related U.S. Application Data
(60) Provisional application No. 62/394,300, filed on Sep. 14, 2016.

(30) Foreign Application Priority Data
Jan. 27, 2017 (JP) 2017-013427

(51) Int. Cl. H02K 33/18

(52) U.S. Cl. CPC H02K 33/18; B06B 1/045

(57) ABSTRACT

A vibration motor includes a stationary portion, a vibrating body, an elastic member, and a damper member. A back yoke is disposed on a magnet. A weight is disposed on the back yoke. The elastic member is disposed between a case and the weight. The weight has a rectangular shape having long sides in a first direction and short sides in a second direction in top view, the first direction being orthogonal to an up-down direction, the second direction being orthogonal to the up-down direction and the first direction. The damper member is disposed between the case and the elastic member. The damper member contacts the elastic member when the vibrating body is in a stationary state.

### CROSS REFERENCE TO RELATED APPLICATIONS

This application claims the benefit of priority to U.S. Patent Application No. 62/394,300 filed on Sep. 14, 2016 and Japanese Patent Application No. 2017-013427 filed on Jan. 27, 2017. The entire contents of these applications are hereby incorporated herein by reference.

### BACKGROUND OF THE INVENTION

### 1. Field of the Invention

The present invention relates to a vibration motor.

### 2. Description of the Related Art

Hitherto, vibration motors have been installed in various devices, such as smartphones. Types of vibration motors include a horizontal-direction linear vibration type and a vertical-direction linear vibration type. Human beings, who are users, tend to feel vertical vibration more than horizontal vibration. An example of an existing vibration motor of the vertical-direction linear vibration type is disclosed in Japanese Unexamined Patent Application Publication No. 2013-85438.

The vibration motor in Japanese Unexamined Patent Application Publication No. 2013-85438 includes a fixing portion, a magnetic field portion, a substrate, a vibrating portion, and an elastic member. The fixing portion includes a case and a bracket. A lower portion of the case is open. The bracket hermetically seals an internal space of the case. The magnetic field portion includes a magnet and a yoke plate. The magnet is fixed to the bracket. The yoke plate is fixed to the magnet. The vibrating portion includes a coil and a mass body. The substrate is fixed to a lower surface of the coil. The elastic member is disposed between the case and the vibrating portion. The coil has an inside diameter that is larger than the outside diameter of the magnet that opposes the coil. Part of the magnet is insertable into a space formed by the coil.

When electric current is passed through the coil via the substrate, a magnetic field that is produced at the coil and a magnetic field that is produced by the magnet interact with each other. This causes the vibrating portion to vibrate in a vertical direction.

In, for example, smartphones and wearable devices in which a vibration motor is installed, in order to perform driving for a long time, large batteries tend to be installed. As a result, there is a limit to where the vibration motor can be disposed and to the volume that can be taken up by the vibration motor. In particular, since dead space in the aforementioned devices corresponds to a rectangular space that is, for example, beside a battery, the vibration motor is required to be disposed in this space.

Therefore, in order to dispose the vibration motor in the aforementioned rectangular space, forming the vibration motor with a rectangular shape instead of a round shape like that in Japanese Unexamined Patent Application Publication No. 2013-85438 may be considered. In this case, a weight of the vibrating body is also rectangular in plan view. However, in such a case, when the vibrating body vibrates in a vertical direction, as shown schematically in FIG. 14, in side view, a vibrating body 200, which includes a weight Wt, may undergo a wavy motion in which a first side end portion and a second side end portion thereof in a long-side direction move oppositely in an up-down direction. In FIG. 14, a double-headed arrow in the up-down direction indicates the direction of vibration of the vibrating body 200, and solid white arrows indicate the wavy motion of the vibrating body 200.

### SUMMARY OF THE INVENTION

An exemplary embodiment of the present application provides a vibration motor including a stationary portion, a vibrating body, an elastic member, and a damper member. The stationary portion includes a base plate, a substrate, a coil, and a case. A vibrating body includes a magnet, a back yoke, and a weight, and is supported so that the vibrating body is capable of vibrating in an up-down direction with respect to the stationary portion. The substrate is disposed on the base plate. The coil is disposed on the substrate. The magnet is disposed so that the magnet is capable of being accommodated at an inner peripheral side of the coil due to vibration, the coil being ring-shaped. The back yoke is disposed on the magnet. The weight is disposed on the back yoke. The case accommodates the coil, the magnet, the back yoke, and the weight. The elastic member is disposed between the case and the weight. The weight has a rectangular shape having long sides in a first direction and short sides in a second direction in top view, the first direction being orthogonal to the up-down direction, the second direction being orthogonal to the up-down direction and the first direction. The damper member is disposed between the case and the elastic member. The damper member contacts the elastic member when the vibrating body is in a stationary state.

An exemplary embodiment of the present application can provide a vibration motor of a vertical-direction linear vibration type that is capable of suppressing a wavy motion when the vibrating body vibrates.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall perspective view of a vibration motor according to an embodiment of the present invention as seen from thereabove.

FIG. 2 is an overall perspective view of the vibration motor according to the embodiment of the present invention as seen from therebelow.

FIG. 3 is a perspective view of a state in which a case has been removed in the vibration motor shown in FIG. 1.

FIG. 4 is a side sectional view of the vibration motor according to the embodiment of the present invention.

FIG. 5 is a top plan view of the state in which the case has been removed in the vibration motor according to the embodiment of the present invention.

FIG. 6 is a perspective view of a structure including an elastic member according to a modification.

FIG. 7 is an overall perspective view of a back yoke.

FIG. 8 schematically illustrates a processing state in a die (metallic plate) when manufacturing a back yoke according to a comparative example.

FIG. 9 schematically illustrates a processing state in a die when manufacturing the back yoke according to the embodiment.

FIG. 10 is a perspective view of a structure in which a substrate and a coil are disposed with respect to a base plate.

FIG. 11 is a plan view of the structure as seen from above FIG. 10.

FIG. 12 is a perspective view of a structure in which the substrate is disposed with respect to the base plate.

FIG. 13 is a perspective view for describing fixing of the coil by using a jig.

FIG. 14 is a schematic view illustrating a wavy motion of a vibrating body.

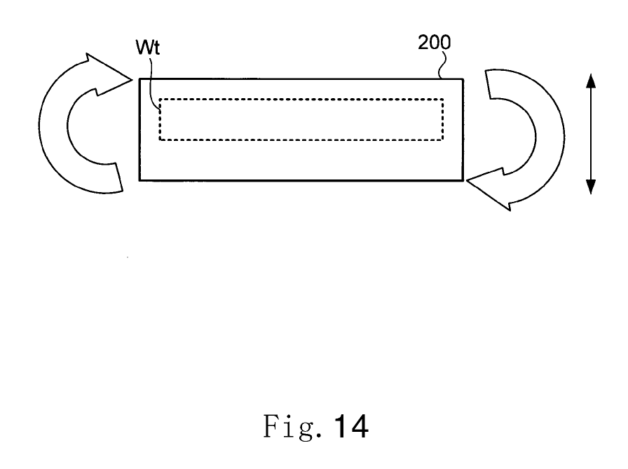

### DETAILED DESCRIPTION OF THE PREFERRED EMBODIMENTS

An exemplary embodiment according to the present invention is described below with reference to the drawings. In the drawings below, the vibration direction of a vibrating body is an up-down direction and indicated as X direction. The term “first direction” that is orthogonal to the up-down direction refers to Y direction. The term “second direction” that is orthogonal to the up-down direction and the first direction refers to Z direction. However, these definitions of the directions do not indicate positional relationships and directions when a vibration motor is actually installed in a device.

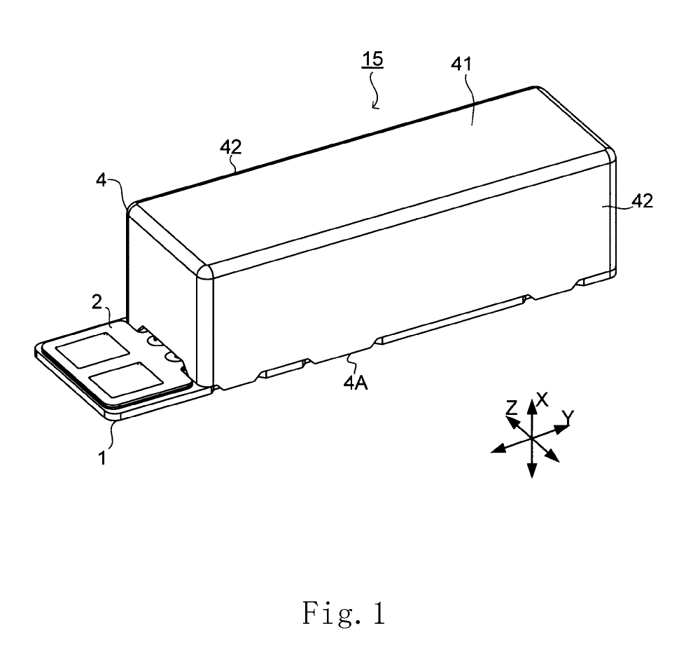

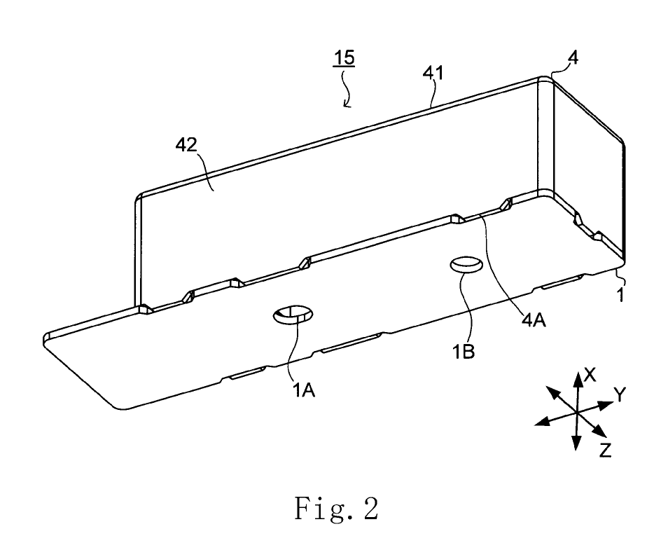

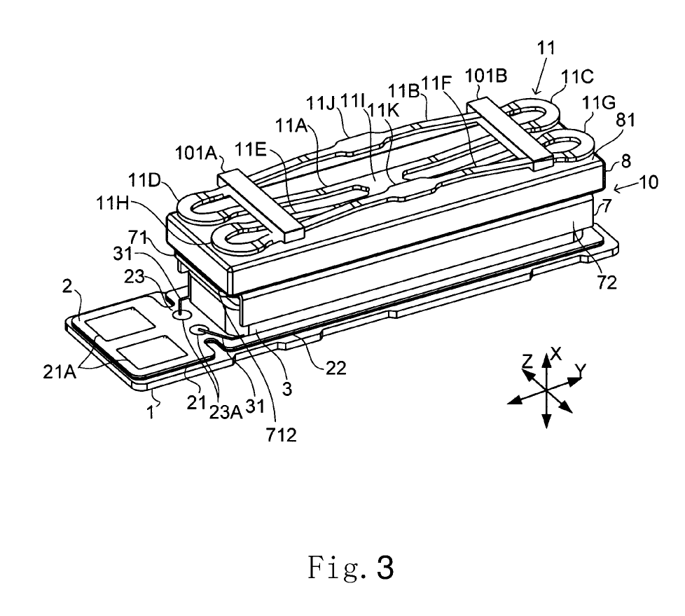

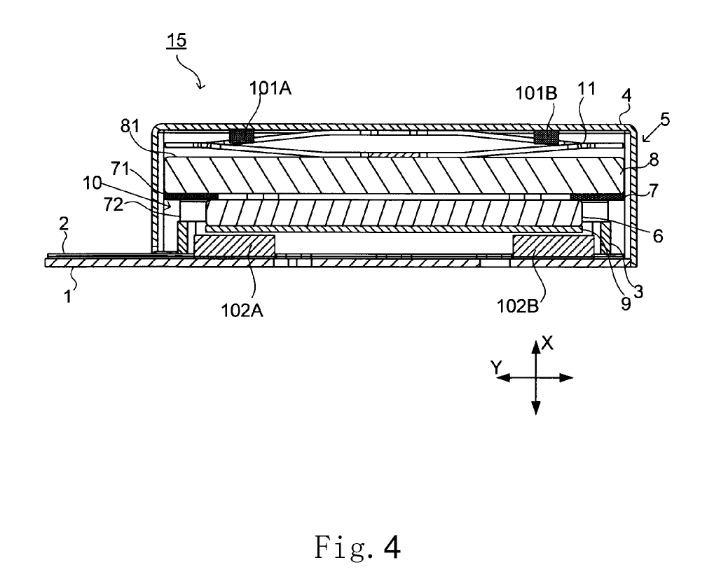

First, a basic overall structure of a vibration motor 15 according to an embodiment of the present invention is described by using FIGS. 1 to 4. FIG. 1 is an overall perspective view of the vibration motor 15 according to the embodiment of the present invention as seen from thereabove. FIG. 2 is an overall perspective view of the vibration motor 15 as seen from therebelow. FIG. 3 is a perspective view of a state in which a case 4 has been removed in the vibration motor 15 shown in FIG. 1. FIG. 4 is a side sectional view of the vibration motor 15.

The vibration motor 15 according to the embodiment roughly includes a stationary portion 5, a vibrating body 10, and an elastic member 11.

The stationary portion 5 includes a base plate 1, a substrate 2, a coil 3, and a case 4. The base plate 1 is, for example, a metallic plate member. The base plate 1 has a rectangular shape having long sides in the first direction and short sides in the second direction in top view.

The substrate 2 is disposed on the base plate 1, and is formed from a flexible printed circuit (FPC). The substrate 2 may be a rigid substrate. The substrate 2 includes a first substrate portion 21, a second substrate portion 22, and a connection portion 23. The first substrate portion 21, the connection portion 23, and the second substrate portion 22 are disposed in that order in the first direction. The width of the first substrate portion 21 in the first direction is smaller than the width of the second substrate portion 22 in the first direction. The widths of the first substrate portion 21 and the second substrate portion 22 in the second direction are the same, and are larger than the width of the connection portion 23 in the second direction.

Two first terminal portions 21A are formed side by side in the second direction at the first substrate portion 21, and have their upper sides exposed. Two second terminal portions 23A are formed side by side in the second direction at the connection portion 23, and have their upper sides exposed. Each first terminal portion 21A and its corresponding second terminal portion 23A that are adjacent to each other in the first direction are electrically connected to each other by a wire of the substrate 2.

The coil 3 is disposed on the second substrate portion 22 of the substrate 2. The coil 3 has a ring shape having long sides in the first direction and short sides in the second direction in top view. A lead wire 31 that is led out from the coil 3 is connected to the second terminal portions 23A. Therefore, by applying a voltage to the first terminal portions 21A from outside the vibration motor 15, it is possible to cause electric current to flow through the coil 3.

The case 4 is a cover member having a rectangular parallelepiped body having long sides in the first direction and short sides in the second direction in top view, with a lower side of the rectangular parallelepiped body being open. The coil 3, the vibrating body 10, and the elastic member 11, are accommodated in an internal space of the case 4.

The vibrating body 10 includes a magnet 6, a back yoke 7, a weight 8, and a pole piece 9. The magnet 6 is a rectangular parallelepiped member having long sides in the first direction and short sides in the second direction in top view.

The back yoke 7 is disposed on the magnet 6, and is made of a magnetic material. The back yoke 7 includes a top surface portion 71 and two long-side protruding portions 72. The top surface portion 71 has a rectangular shape having long sides in the first direction and short sides in the second direction in top view. The long-side protruding portions 72 protrude downward from respective long-side portions of the top surface portion 72 that oppose each other in the second direction.

The weight 8 is disposed on the back yoke 7, and is made of, for example, a tungsten alloy. The weight 8 is a rectangular parallelepiped member having long sides in the first direction and short sides in the second direction in top view.

The pole piece 9 is disposed on a lower surface of the magnet 6, and is a plate member made of a magnetic material. The pole piece 9 has a rectangular shape having long sides in the first direction and short sides in the second direction in top view. The magnet 6, the back yoke 7, and the pole piece 9 form a magnetic path.

A first end side of the elastic member 11 is fixed to a lower surface of a top surface portion 41 of the case 4, and a second end side of the elastic member 11 is fixed to an upper surface 81 of the weight 8. That is, the elastic member 11 is disposed between the case 4 and the weight 8. This causes the vibrating body 10 to be supported so that the vibrating body 10 is capable of vibrating in the up-down direction with respect to the stationary portion 5.

The magnet 6 and the pole piece 9 are accommodated in a space at an inner peripheral side of the coil 3 depending upon their positions when they vibrate. That is, the magnet 6 is disposed so that the magnet 6 is capable of being accommodated at the inner peripheral side of the ring-shaped coil 3 due to the vibration.

By applying a voltage to the first terminal portions 21A of the substrate 2 from outside the vibration motor 15, electric current flows through the coil 3, and a magnetic field produced at the coil 3 and a magnetic field produced by the magnet 6, the back yoke 7, and the pole piece 9 interact each other. This causes the vibrating body 10 to vibrate in the up-down direction. Therefore, the vibration motor 15 is a vertical-direction linear vibration type motor.

As described above, the base plate 1, the case 4, the magnet 6, the back yoke 7, and the weight 8 each have a rectangular shape having long sides in the first direction and short sides in the second direction in top view. Therefore, the vertical-direction linear vibration type vibration motor 15 can be disposed in a rectangular dead space that is, for example, beside a battery in a device, such as a smartphone or a wearable device.

The vibration motor 15 further includes damper members 101A and 101B and lower damper members 102A and 102B, and these are described later.

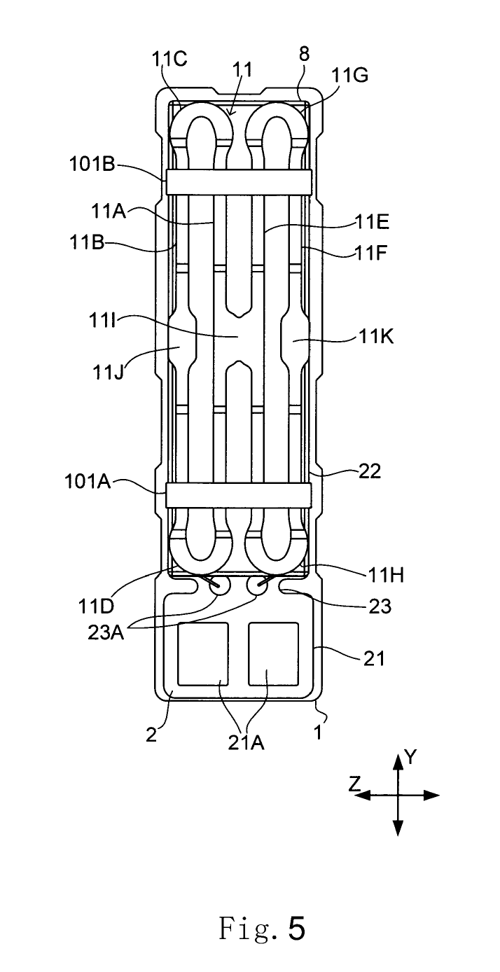

Next, a more specific structure of the elastic member 11 is described with reference to FIG. 5. FIG. 5 is a top plan view of a state in which the case 4 has been removed in the vibration motor 15.

As shown in FIG. 5, the elastic member 11 includes a first extending portion 11A, a second extending portion 11B, a first connection portion 11C, a second connection portion 11D, a third extending portion 11E, a fourth extending portion 11F, a third connection portion 11G, a fourth connection portion 11H, and a fifth connection portion 11I. These portions are formed into one and the same member.

The first extending portion 11A and the second extending portion 11B extend in the first direction and are adjacent to each other in the second direction in top view. The first connection portion 11C connects a first end portion of the first extending portion 11A and a first end portion of the second extending portion 11B. The second connection portion 11D connects a second end portion of the first extending portion 11A and a second end portion of the second extending portion 11B.

The third extending portion 11E extends in the first direction and opposes the first extending portion 11A in the second direction. The fourth extending portion 11F extends in the first direction and is adjacent to the third extending portion 11E in the second direction in top view. The third connection portion 11G connects a first end portion of the third extending portion 11E and a first end portion of the fourth extending portion 11F. The fourth connection portion 11H connects a second end portion of the third extending portion 11E and a second end portion of the fourth extending portion 11F.

The fifth connection portion 11I connects a central portion of the first extending portion 11A and a central portion of the third extending portion 11E in the second direction.

By virtue of such a structure, only one elastic member needs to be used, so that the number of components can be reduced.

Further, also with reference to FIG. 3, in the structure of the elastic member 11, the first extending portion 11A is inclined upward from its central portion towards both of the end portions thereof. The second extending portion 11B is inclined upward from both of the end portions thereof towards its central portion. The second extending portion 11B includes a weld portion 11J at an uppermost portion of the inclination thereof. The third extending portion 11E is inclined upward from its central portion towards both of the end portions thereof. The fourth extending portion 11F is inclined upward from both of the end portions thereof towards its central portion. The fourth extending portion 11F includes a weld portion 11K at an uppermost portion of the inclination thereof.

By virtue of such a structure, the fifth connection portion 11I is fixed to the upper surface 81 of the weight 8 by welding, and the weld portions 11J and 11K that are positioned above the fifth connection portion 11I are fixed to the lower surface of the top surface portion 41 of the case 4, so that the vibrating body 10 can be supported so that the vibrating body 10 is capable of vibrating with respect to the case 4.

As shown in FIG. 3, the damper members 101A and 101B are provided between the lower surface of the top surface portion 41 (not shown in FIG. 3) of the case 4 and the elastic member 11. The damper members 101A and 101B each have a parallelepiped shape having long sides in the second direction. The damper member 101A is disposed on a first side in the first direction, and the damper member 101B is disposed on a second side in the first direction.

Upper surfaces of the damper members 101A and 101B are fixed to the lower surface of the top surface portion 41 of the case 4 with, for example, a double-sided tape. When electric current does not flow through the coil 3 and the vibrating body 10 is in a stationary state, a lower surface of the damper member 101A contacts a first side end portion of the second extending portion 11B of the elastic member 11 in the first direction and a first side end portion of the fourth extending portion 11F of the elastic member 11 in the first direction. When the vibrating body 10 is in the stationary state, a lower surface of the damper member 101B contacts a second side end portion of the second extending portion 11B of the elastic member 11 in the first direction and a second side end portion of the fourth extending portion 11F of the elastic member 11 in the first direction.

By virtue of such a structure, when vibrating the vibrating body 10 by operating the vibration motor 15, it is possible to suppress, in side view, a wavy motion of the weight 8 in which a first end portion and a second end portion of the weight 8 in the first direction move oppositely in the up-down direction.

The damper members may be fixed to the elastic member without fixing them to the case. However, it is desirable to fix the damper members to the case rather than to the elastic member because the area of a fixing portion can be made large.

Accordingly, the vibration motor 15 according to the embodiment includes the stationary portion 5 including the base plate 1, the substrate 2, the coil 3, and the case 4; the vibrating body 10 that includes the magnet 6, the back yoke 7, and the weight 8 and that is supported so that it is capable of vibrating in the up-down direction with respect to the stationary portion 5; the elastic member 11; and the damper members 101A and 101B.

The substrate 2 is disposed on the base plate 1. The coil 3 is disposed on the substrate 2. The magnet 6 is disposed so that the magnet 6 is capable of being accommodated at the inner peripheral side of the ring-shaped coil 3 due to vibration. The back yoke 7 is disposed on the magnet 6. The weight 8 is disposed on the back yoke 7.

The case 4 accommodates the coil 3, the magnet 6, the back yoke 7, and the weight 8. The elastic member 11 is disposed between the case 4 and the weight 8. The weight 8 has a rectangular shape having long sides in the first direction and short sides in the second direction in top view. The first direction is orthogonal to the up-down direction and the second direction is orthogonal to the up-down direction and the first direction.

The damper members 101A and 101B are disposed between the case 4 and the elastic member 11. The damper members 101A and 101B contact the elastic member 11 when the vibrating body 10 is in the stationary state.

By virtue of such a structure, it is possible to suppress a wavy motion of the vibrating body 10 when the vibrating body 10 vibrates in the vibration motor 15 of the vertical-direction linear vibration type.

The elastic member 11 includes the first extending portion 11A that extends in the first direction, the second extending portion 11B that extends in the first direction, the first connection portion 11C that connects the first end portion of the first extending portion 11A and the first end portion of the second extending portion 11B, the second connection portion 11D that connects the second end portion of the first extending portion 11A and the second end portion of the second extending portion 11B, the third extending portion 11E that extends in the first direction and that opposes the first extending portion 11A in the second direction, the fourth extending portion 11F that extends in the first direction, the third connection portion 11G that connects the first end portion of the third extending portion 11E and the first end portion of the fourth extending portion 11F, the fourth connection portion 11H that connects the second end portion of the third extending portion 11E and the second end portion of the fourth extending portion 11F, and the fifth connection portion 11I that connects in the second direction the central portion of the first extending portion 11A and the central portion of the third extending portion 11E.

Further, the first extending portion 11A is inclined upward from its central portion towards both of the end portions thereof. The second extending portion 11B is inclined upward from both of the end portions thereof towards its central portion. The third extending portion 11E is inclined upward from its central portion towards both of the end portions thereof. The fourth extending portion 11F is inclined upward from both of the end portions thereof towards its central portion.

Of the two damper members 101A and 101B that are disposed in the first direction, in the aforementioned stationary state, the damper member 101A contacts a first side of the second extending portion 11B in the first direction and a first side of the fourth extending portion 11F in the first direction; and of the two damper members 101A and 101B that are disposed in the first direction, in the aforementioned stationary state, the damper member 101B contacts a second side of the second extending portion 11B in the first direction and a second side of the fourth extending portion 11F in the first direction.

By virtue of such a structure, the central portion of the second extending portion 11B and the central portion of the fourth extending portion 11F are fixed to the case 4 and the fifth connection portion 11I is fixed to the weight 8, so that the vibrating body 10 can be supported so that the vibrating body 10 is capable of vibrating. Only one elastic member needs to be used, so that the number of components can be reduced. In addition, it is possible to suppress a wavy motion of the vibrating body 10 by the two damper members 101A and 101B.

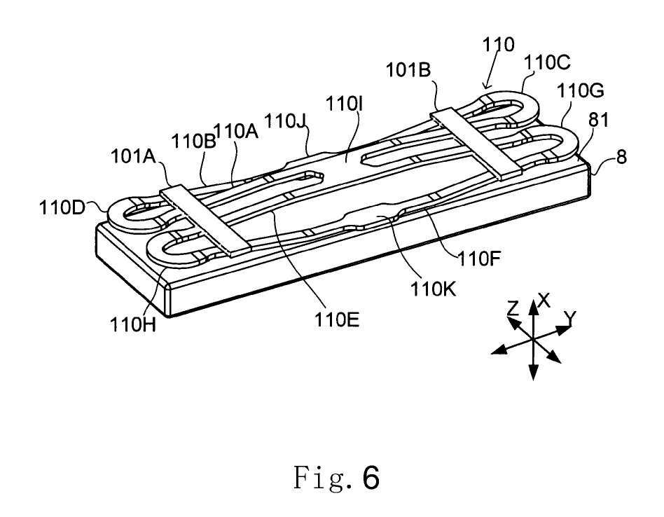

As a modification of the elastic member, an elastic member 110 having a structure such as that shown in FIG. 6 may be used. In the elastic member 110, a first extending portion 110A is inclined downward from its central portion towards both end portions thereof. A second extending portion 110B is inclined downward from both end portions thereof towards its central portion. The second extending portion 110B includes a weld portion 110J at a lowermost portion of the inclination thereof. A third extending portion 110E is inclined downward from its central portion towards both end portions thereof. A fourth extending portion 110F is inclined downward from both end portions thereof towards its central portion. The fourth extending portion 110F includes a weld portion 110K at a lowermost portion of the inclination thereof.

By virtue of such a structure, the weld portions 110J and 110K are fixed to the upper surface 81 of the weight 8 by welding, and a fifth connection portion 110I that is positioned above the weld portions 110J and 110K is fixed to the lower surface of the top surface portion 41 of the case 4 by welding, so that the vibrating body 10 can be supported so that the vibrating body 10 is capable of vibrating with respect to the case 4.

Of damper members 101A and 101B having the same structure as that described above, in the stationary state of the vibrating body 10, a lower surface of the damper member 101A contacts a first side end portion of the first extending portion 110A in the first direction and a first side end portion of the third extending portion 110E in the first direction. In the stationary state of the vibrating body 10, a lower surface of the damper member 101B contacts a second side end portion of the first extending portion 110A in the first direction and a second side end portion of the third extending portion 110E in the first direction.

That is, the elastic member 110 includes the first extending portion 110A that extends in the first direction, the second extending portions 110B that extends in the first direction, a first connection portion 110C that connects a first end portion of the first extending portion 110A and a first end portion of the second extending portion 110B, a second connection portion 110D that connects a second end portion of the first extending portion 110A and a second end portion of the second extending portion 110B, the third extending portion 110E that extends in the first direction and that opposes the first extending portion 110A in the second direction, the fourth extending portion 110F that extends in the first direction, a third connection portion 110G that connects a first end portion of the third extending portion 110E and a first end portion of the fourth extending portion 110F, a fourth connection portion 110H that connects a second end portion of the third extending portion 110E and a second end portion of the fourth extending portion 110F, and a fifth connection portion 110I that connects a central portion of the first extending portion 110A and a central portion of the third extending portion 110E in the second direction.

The first extending portion 110A is inclined downward from its central portion towards both of the end portions thereof. The second extending portion 110B is inclined downward from both of the end portions thereof towards its central portion. The third extending portion 110E is inclined downward from its central portion towards both of the end portions thereof. The fourth extending portion 110F is inclined downward from both of the end portions thereof towards its central portion.

Of the two damper members 101A and 101B that are disposed in the first direction, in the aforementioned stationary state, the damper member 101A contacts a first side of the first extending portion 110A in the first direction and a first side of the third extending portion 110E in the first direction; and of the two damper members 101A and 101B that are disposed in the first direction, in the aforementioned stationary state, the damper member 101B contacts a second side of the first extending portion 110A in the first direction and a second side of the third extending portion 110E in the first direction.

By virtue of such a structure, the central portion of the second extending portion 110B and the central portion of the fourth extending portion 110F are fixed to the weight and the fifth connection portion 110I is fixed to the case 4, so that the vibrating body 10 can be supported so that the vibrating body 10 is capable of vibrating. Only one elastic member 110 needs to be used, so that the number of components can be reduced. In addition, it is possible to suppress a wavy motion of the vibrating body 10 by the two damper members 101A and 101B.

In the elastic member 11 (FIG. 5), the widths of the first connection portion 11C, the second connection portion 11D, the third connection portion 11G, and the fourth connection portion 11H are larger than the widths of the first extending portion 11A, the second extending portion 11B, the third extending portion 11E, and the fourth extending portion 11F. This makes it possible to distribute the stress applied to the elastic member 11 when the vibrating body 10 vibrates. This similarly applies to the elastic member 110 (FIG. 6) according to the modification.

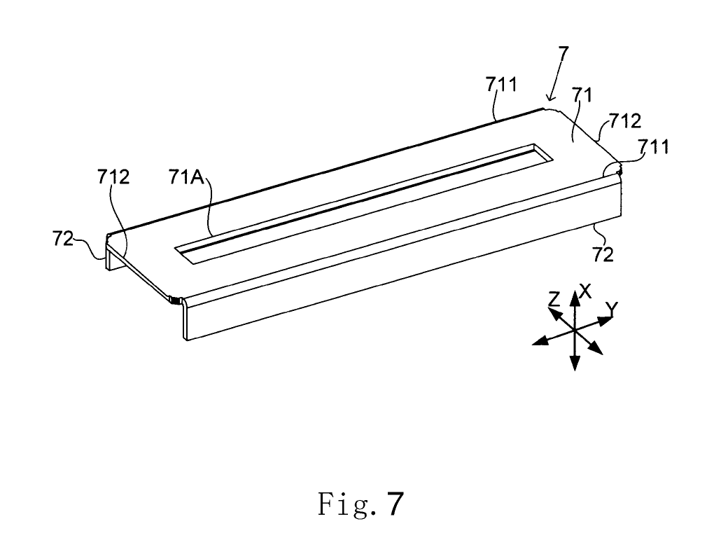

Next, a structure of the back yoke 7 is described. FIG. 7 is an overall perspective view of the back yoke 7.

As shown in FIG. 7, the back yoke 7 includes the rectangular top surface portion 71 and two long-side protruding portions 72. These portions are formed into one and the same member. The long-side protruding portions 72 protrude downward from respective long-side portions 711 of the top surface portion 71. Protruding portions that protrude downward from respective short-side portions 712 of the top surface portion 71 are not provided.

That is, the back yoke 7 includes the rectangular top surface portion 71 including the long-side portions 711 in the first direction and the short-side portions 712 in the second direction, and the long-side protruding portions 72 that protrude downward from the respective long-side portions 711 of the top surface portion 71. The back yoke 7 does not include short-side protrusions that protrude downward from the respective short-side portions 712 of the top surface portion 71.

Therefore, even if the vibrating body 10 undergoes a wavy motion when the vibrating body 10 vibrates, since the back yoke 7 does not include short-side protruding portions, the back yoke 7 is prevented from contacting outer peripheral surfaces of end portions of the coil 3 in the first direction. As shown in FIG. 3, the lead wire 31 of the coil 3 is positioned below one of the short-side portions 712 of the top surface portion 71. However, since the short-side portions 712 do not include short-side protruding portions, it is possible to prevent the back yoke 7 from contacting the lead wire 31.

The back yoke 7 and the magnet 6 form a magnetic path. The long-side protruding portions 72 contribute more to the formation of the magnetic path than short-side protruding portions if they are provided. Therefore, there is no problem even if short-side protruding portions are not provided.

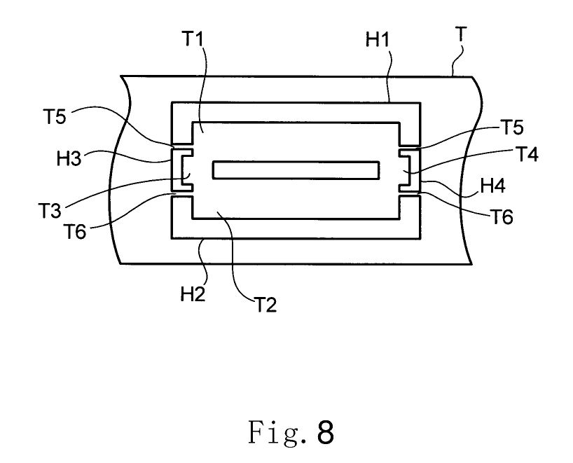

When the back yoke 7 has this structure, manufacturing effects are also provided. FIG. 8 schematically illustrates a processing state in a die T (metallic plate) when manufacturing a back yoke including long-side protruding portions and short-side protruding portions. In this case, holes H1 and H2 for forming the long-side protruding portions and holes H3 and H4 for forming the short-side protruding portions are formed in the die T. The long-side protruding portions can be formed by bending a long-side region T1 surrounded by the hole H1 and a long-side region T2 surrounded by the hole H2. The short-side protruding portions can be formed by bending a short-side region T3 surrounded by the hole H3 and a short-side region T4 surrounded by the hole H4.

At this time, by a supporting portion T5 that is positioned between the holes H1 and H3 and a supporting portion T5 that is positioned between the holes H1 and H4 and a supporting portion T6 that is positioned between the holes H2 and H3 and a supporting portion T6 that is positioned between the holes H2 and H4, a portion that becomes a product is supported at the die T. By cutting the supporting portions T5 and T6, the back yoke, which is the product, can be removed from the die T. However, since regions of the supporting portions T5 and T6 are small, for example, the regions may be accidentally cut during, for example, the bending operation. This may lead to manufacturing problems.

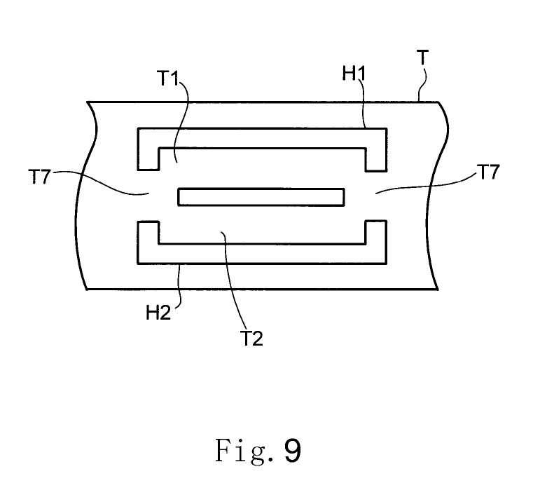

In contrast, FIG. 9 schematically illustrates a processing state in a die T when manufacturing a back yoke that does not include short-side protruding portions as in the embodiment. In this case, holes H1 and H2 for forming long-side protruding portions are formed in the die T. The long-side protruding portions can be formed by bending a long-side region T1 surrounded by the hole H1 and a long-side region T2 surrounded by the hole H2. In this state, by supporting portions T7 that are positioned between the holes H1 and H2, a portion that becomes a product is supported at the die T. By cutting the supporting portions T7, the back yoke, which is the product, can be removed from the die T. Since the supporting portions T7 are less likely to be cut than the supporting portions T5 and T6 in FIG. 8, it is possible to increase processing stability.

The top surface portion 71 of the back yoke 7 has a through hole 71A that extends therethrough in the up-down direction. In top view, the through hole 71A overlaps an upper surface of the magnet 6. That is, a surface of the back yoke 7 to which the magnet 6 is fixed has the through hole 71A that extends therethrough in the up-down direction.

Therefore, when, with the magnet 6 fixed to the top surface portion 71 by magnetic force, an adhesive is made to flow into the through hole 71A and the magnet 6 is fixed to the top surface portion 71, protrusion of the adhesive to the outer side of the magnet 6 can be suppressed.

Even in a method of fixing the magnet 6 to the top surface portion 71 by bringing the magnet 6 and the top surface portion 71 into contact with each other with an adhesive previously applied to a region along a periphery of the through hole 71A or to a surface of the magnet 6 corresponding to the region along the periphery of the through hole 71A, part of the adhesive is made to flow into the through hole 71A. Therefore, protrusion of the adhesive to the outer side of the magnet 6 can be suppressed. That is, the adhesive can escape into the through hole 71A.

In addition, for example, as with the magnet 6, even in a method of fixing the weight 8 to the top surface portion 71 by bringing the weight 8 and the top surface portion 71 into contact with each other with an adhesive previously applied to a region along a periphery of the through hole 71A or to a surface of the weight 8 corresponding to the region along the periphery of the through hole 71A, part of the adhesive is made to escape into the through hole 71A. Therefore, protrusion of the adhesive to the outer side of the weight 8 can be suppressed.

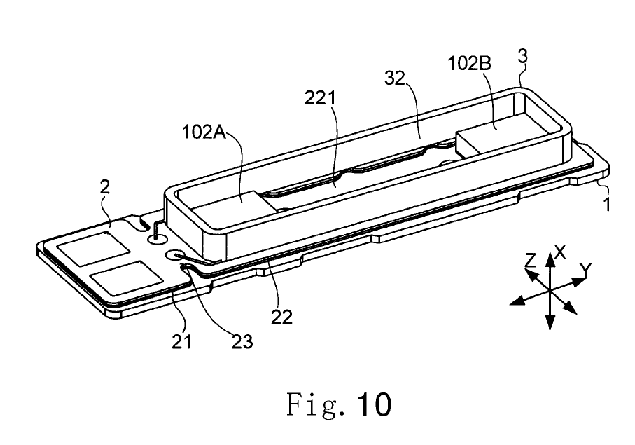

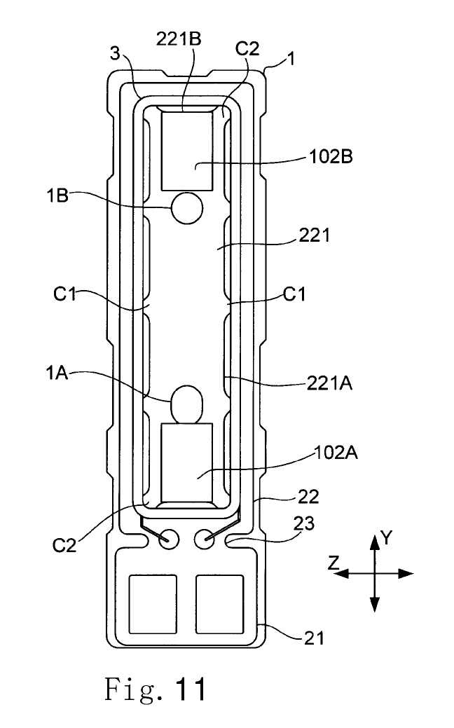

Next, a more specific structure of the substrate 2 is described. FIG. 10 is a perspective view of a structure in which the substrate 2 and the coil 3 are disposed with respect to the base plate 1 in the vibration motor 15. FIG. 11 is a plan view of the structure as seen from above FIG. 10.

The coil 3 includes an internal space 32 at an inner peripheral side thereof. The second substrate portion 22 of the substrate 2 has a through region 221 that extends therethrough in the up-down direction. Edge portions of the through region 221 include long-side edge portions 221A opposing each other in the second direction and short-side edge portions 221B that oppose each other in the first direction. Each long-side edge portion 221A has three cutout portions C1 that are recessed towards an outer periphery thereof. Further, cutout portions C2 that are recessed towards the outer periphery are formed at four corners defined by the edge portions of the through region 221, that is, at the locations where the long-side edge portions 221A and the short-side edge portions 221B are adjacent to each other. The edges of the internal space 32 of the coil 3 are positioned above the cutout portions C1 and C2.

That is, the substrate 2 includes the through region 221 that extends therethrough in the up-down direction at the inner peripheral side of the coil 3, and includes the plurality of cutout portions C1 and C2 at the edge portions of the through region 221.

In fixing the coil 3 to the base plate 1, an adhesive is applied to each of the cutout portions C1 and C2. By pushing the coil 3 against the second substrate portion 22 from above the cutout portions C1 and C2, the coil 3 can be fixed to the base plate 1 while interposing the second substrate portion 22 between the coil 3 and the base plate 1. Therefore, it is possible to suppress peeling of the substrate 2 from the base plate 1.

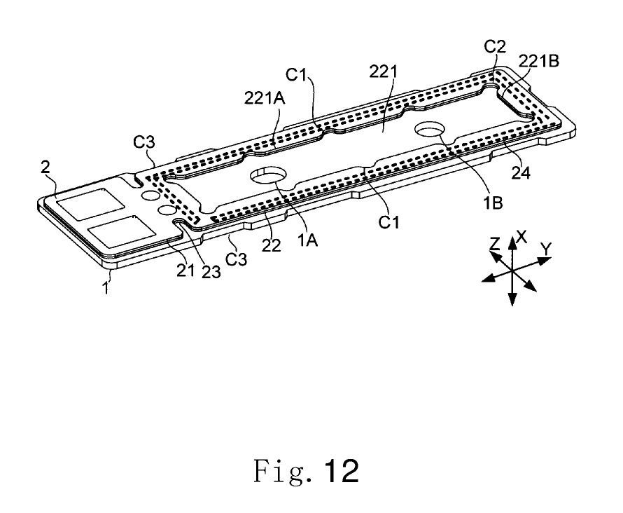

FIG. 12 is a perspective view of a structure in which the substrate 2 is disposed with respect to the base plate 1.

In the second substrate portion 22, a closed circuit pattern 24 is provided along a periphery of the through region 221. The closed circuit pattern 24 is a closed wire pattern (such as a copper foil pattern), and does not pass electric current therethrough. Although, in FIG. 12, the closed circuit pattern 24 is formed in the substrate 2, the closed circuit pattern 24 may be exposed at an upper surface of the substrate 2. Although the closed circuit pattern 24 in FIG. 12 has a form in which both end portions are not connected, the closed circuit pattern 24 may have a form in which both of the end portions are connected, that is, may be a ring-shaped pattern. Alternatively, the closed circuit pattern 24 may be a straight-line pattern that is divided at the sides of the edge portions of the through region 221.

Therefore, the closed circuit pattern 24 can increase the strength of the second substrate portion 22 whose strength is reduced when the through region 221 is provided.

In the embodiment, as shown in FIGS. 10 and 11, the lower damper members 102A and 102B are disposed in the internal space 32 of the coil 3. The lower damper members 102A and 102B are disposed on respective ends of the internal space 32 in the first direction. The lower damper members 102A and 102B are fixed to an upper surface of the base plate 1 that is exposed at an upper side thereof by the through region 221. That is, the lower damper members 102A and 102B are disposed on the inner peripheral side of the coil 3.

During ordinary vibration of the vibrating body 10, a lower surface of the vibrating body 10 does not contact the lower damper members 102A and 102B. When, for example, the vibration motor 15 is accidentally dropped, the vibrating body 10 moves downward and contacts the lower damper members 102A and 102B. Therefore, it is possible to prevent the vibration motor 10 from moving excessively downward. This makes it possible to suppress, for example, excessive deformation of the elastic member 11. The lower damper members may be disposed on the upper surface of the substrate instead of on the base plate.

Next, a more specific structure of the base plate 1 is described. As shown in FIG. 12, a region of the base plate 1 within the through region 221 has two hole portions 1A and 1B having different shapes and extending therethrough in the up-down direction. The hole portions 1A and 1B are disposed in the first direction.

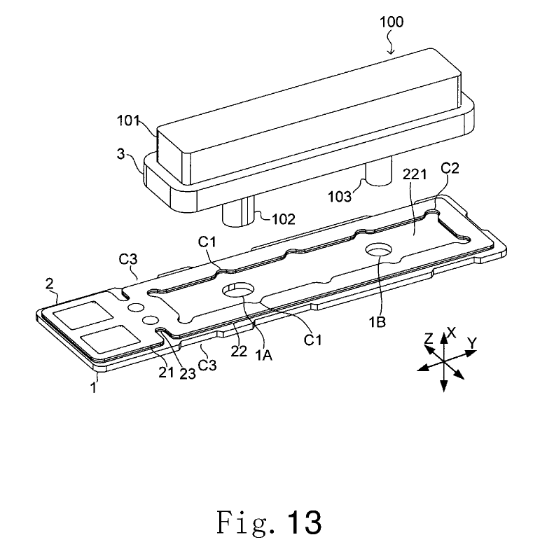

The hole portions 1A and 1B are used in fixing the coil 3 to the substrate 2. As shown in FIG. 13, in fixing the coil 3 to the substrate 2, a jig (bobbin) 100 is used. The jig 100 includes a base section 101, and bosses 102 and 103 that protrude downward from the base section 101. The boss 102 has a sectional shape that corresponds to the shape of the hole portion 1A. The boss 103 has a sectional shape that corresponds to the shape of the hole portion 1B.

The boss 102 of the jig 100 around whose base section 101 the coil 3 is wound is passed through the hole portion 1A and the boss 103 thereof is passed through the hole portion 1B, so that the coil 3 is disposed on the substrate 2. At this time, as mentioned above, an adhesive is applied to the cutout portions C1 and C2 of the substrate 2, so that the coil 3 is fixed to the base plate 1. Thereafter, the jig 100 is removed from the coil 3.

Since the hole portions 1A and 1B have different shapes, in fixing the coil 3, the jig 100 can be easily faced with respect to the hole portions 1A and 1B.

As shown in FIG. 12, each cutout recessed portion C3 is provided in a corresponding one of side portions of the base plate 1 that oppose each other in the second direction. In the example in FIG. 12, each side portion has three cutout recessed portions C3 that are provided side by side in the first direction.

On the other hand, as shown in FIGS. 1 and 2, the case 4 includes side surface portions 42 that oppose each other in the second direction. Each side surface portion 42 has three protruding portions 4A that protrude downward and that are provided side by side in the first direction.

The protruding portions 4A are fitted into the corresponding cutout recessed portions C3. That is, the cutout recessed portions C3 are each provided in a corresponding one of the side portions of the base plate 1 that oppose each other in the second direction; the case 4 includes the side surface portions 42 that oppose each other in the second direction; and the side surface portions 42 include the protruding portions 4A that protrude downward, and the protruding portions 4A are fitted to the cutout recessed portions C3. Therefore, the case 4 is easily positioned when fixing the case 4 to the base plate 1.

### Others

Although an embodiment of the present invention is described, the embodiment may be variously modified within the scope of the gist of the present invention.

The present invention is usable in, for example, vibration motors installed in, for example, a smartphone or a wearable device.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion that includes a base plate, a substrate, a coil, and a case;
a vibrating body that includes a magnet, a back yoke, and a weight, and that is supported so that the vibrating body is capable of vibrating in an up-down direction with respect to the stationary portion;
an elastic member; and
a damper member,
wherein the substrate is disposed on the base plate,
wherein the coil is disposed on the substrate,
wherein the magnet is disposed so that the magnet is capable of being accommodated at an inner peripheral side of the coil due to vibration, the coil being ring-shaped,
wherein the back yoke is disposed on the magnet,
wherein the weight is disposed on the back yoke,
wherein the case accommodates the coil, the magnet, the back yoke, and the weight,
wherein the elastic member is disposed between the case and the weight,
wherein the weight has a rectangular shape having long sides in a first direction and short sides in a second direction in top view, the first direction being orthogonal to the up-down direction, the second direction being orthogonal to the up-down direction and the first direction,
wherein the damper member is disposed between the case and the elastic member, and
wherein the damper member contacts the elastic member when the vibrating body is in a stationary state.

2. The vibration motor according to claim 1, wherein the elastic member includes
a first extending portion that extends in the first direction,
a second extending portion that extends in the first direction,
a first connection portion that connects a first end portion of the first extending portion and a first end portion of the second extending portion,
a second connection portion that connects a second end portion of the first extending portion and a second end portion of the second extending portion,
a third extending portion that extends in the first direction and that opposes the first extending portion in the second direction,
a fourth extending portion that extends in the first direction,
a third connection portion that connects a first end portion of the third extending portion and a first end portion of the fourth extending portion,
a fourth connection portion that connects a second end portion of the third extending portion and a second end portion of the fourth extending portion, and
a fifth connection portion that connects in the second direction a central portion of the first extending portion and a central portion of the third extending portion,
wherein the first extending portion is inclined upward from the central portion thereof towards both of the end portions thereof,
wherein the second extending portion is inclined upward from both of the end portions thereof towards a central portion thereof,
wherein the third extending portion is inclined upward from the central portion thereof towards both of the end portions thereof,
wherein the fourth extending portion is inclined upward from both of the end portions thereof towards a central portion thereof,
wherein two of the damper members are provided, the damper members being disposed in the first direction,
wherein, in the stationary state, one of the two damper members contacts a first side of the second extending portion in the first direction and a first side of the fourth extending portion in the first direction, and
wherein, in the stationary state, the other of the two damper members contacts a second side of the second extending portion in the first direction and a second side of the fourth extending portion in the first direction.

3. The vibration motor according to claim 2, wherein widths of the first to fourth connection portions are larger than widths of the first to fourth extending portions.

4. The vibration motor according to claim 1, wherein the elastic member includes
a first extending portion that extends in the first direction,
a second extending portion that extends in the first direction,
a first connection portion that connects a first end portion of the first extending portion and a first end portion of the second extending portion,
a second connection portion that connects a second end portion of the first extending portion and a second end portion of the second extending portion,
a third extending portion that extends in the first direction and that opposes the first extending portion in the second direction,
a fourth extending portion that extends in the first direction,
a third connection portion that connects a first end portion of the third extending portion and a first end portion of the fourth extending portion,
a fourth connection portion that connects a second end portion of the third extending portion and a second end portion of the fourth extending portion, and
a fifth connection portion that connects in the second direction a central portion of the first extending portion and a central portion of the third extending portion,
wherein the first extending portion is inclined downward from the central portion thereof towards both of the end portions thereof,
wherein the second extending portion is inclined downward from both of the end portions thereof towards a central portion thereof,
wherein the third extending portion is inclined downward from the central portion thereof towards both of the end portions thereof,
wherein the fourth extending portion is inclined downward from both of the end portions thereof towards a central portion thereof,
wherein two of the damper members are provided, the damper members being disposed in the first direction,
wherein, in the stationary state, one of the two damper members contacts a first side of the first extending portion in the first direction and a first side of the third extending portion in the first direction, and
wherein, in the stationary state, the other of the two damper members contacts a second side of the first extending portion in the first direction and a second side of the third extending portion in the first direction.

5. The vibration motor according to claim 4, wherein widths of the first to fourth connection portions are larger than widths of the first to fourth extending portions.

6. The vibration motor according to claim 1, wherein the back yoke includes a rectangular top surface portion and long-side protruding portions, the top surface portion including long-side portions in the first direction and short-side portions in the second direction, the long-side protruding portions protruding downward from the long-side portions of the top surface portion, and
wherein the back yoke does not include short-side protruding portions that protrude downward from the short-side portions of the top surface portion.

7. The vibration motor according to claim 6, wherein a surface of the back yoke to which the magnet is fixed has a through hole that extends therethrough in the up-down direction.

8. The vibration motor according to claim 6, further comprising a lower damper member at the inner peripheral side of the coil.

9. The vibration motor according to claim 6, wherein the substrate has a through region that extends in the up-down direction therethrough at the inner peripheral side of the coil, and
wherein edge portions of the through region have a plurality of cutout portions.

10. The vibration motor according to claim 9, wherein a region of the base plate within the through region has two hole portions having different shapes and extending therethrough in the up-down direction.

11. The vibration motor according to claim 9, wherein a closed circuit pattern is provided along a periphery of the through region.

12. The vibration motor according to claim 11, wherein a region of the base plate within the through region has two hole portions having different shapes and extending therethrough in the up-down direction.

13. The vibration motor according to claim 6, wherein the base plate includes side portions that oppose each other in the second direction, each side portion having a cutout recessed portion,
wherein the case includes side surface portions that oppose each other in the second direction,
wherein each side surface portion has a protruding portion that protrudes downward, and
wherein each protruding portion is fitted to a corresponding one of the cutout recessed portions.
